(19) United States
(12) Patent Application Publication
(10) Pub. No.: US 2018/0331381 A1
(43) Pub. Date: Nov. 15, 2018

(54) METHOD FOR MANUFACTURING PROTONIC CERAMIC FUEL CELLS

(71) Applicant: KOREA INSTITUTE OF SCIENCE AND TECHNOLOGY, Seoul (KR)

(72) Inventors: Jong Ho LEE, Seoul (KR); Hyeg Soon AN, Seoul (KR); Sung Min CHOI, Seoul (KR); Kyung Joong YOON, Seoul (KR); Ji-Won SON, Seoul (KR); Byung Kook KIM, Seoul (KR); Hae-Weon LEE, Seoul (KR); Mansoo PARK, Seoul (KR); Hyoungchul KIM, Seoul (KR); Ho-Il JI, Seoul (KR)

(21) Appl. No.: 15/975,374

(22) Filed: May 9, 2018

(30) Foreign Application Priority Data
May 11, 2017 (KR) 10-2017-0058467

(51) Int. Cl. H01M 8/126; H01M 4/86; H01M 4/90; H01M 4/88; H01M 8/1226

(52) U.S. Cl. CPC H01M 8/126; H01M 4/8621; H01M 4/9066; H01M 2004/8689; H01M 8/1226; H01M 2004/8684; H01M 4/8885

(57) ABSTRACT

The present invention relates to a method for manufacturing a protonic ceramic fuel cell, more particularly to a method for manufacturing a protonic ceramic fuel cell, which includes an electrolyte layer with a dense structure and has very superior interfacial bonding between the electrolyte layer and a cathode layer.

### CROSS-REFERENCE TO RELATED APPLICATIONS

This application claims, under 35 U.S.C. § 119, the priority of Korean Patent Application No. 10-2017-0058467, filed on May 11, 2017, in the Korean Intellectual Property Office, the disclosure of which is incorporated herein by reference in its entirety.

### BACKGROUND

### (a) Technical Field

The present invention relates to a method for manufacturing a protonic ceramic fuel cell, more particularly to a method for manufacturing a protonic ceramic fuel cell, which includes an electrolyte layer with a dense structure and has very superior interfacial bonding between the electrolyte layer and a cathode layer.

### (b) Background Art

A fuel cell is a device which converts the chemical energy of a fuel into electrical energy. It is considered as one of the future energy sources that can replace existing internal combustion engines due to high conversion efficiency, environment-friendliness, etc. Among the fuel cells, a solid oxide fuel cell (SOFC) is advantageous in that the theoretical efficiency is the highest, various hydrocarbon-based fuels can be used and a precious metal catalyst is unnecessary due to high operating temperature.

However, the solid oxide fuel cell (SOFC) has problems in terms of system cost increases, durability and reliability due to the high operating temperature because oxygen ion conductors are commonly used as electrolyte materials. Therefore, researches are being conducted actively to lower the operating temperature of the solid oxide fuel cell (SOFC) to intermediate-to-low temperature ranges.

As a result, a protonic ceramic fuel cell (PCFC) using a proton conductor or a proton-conducting oxide, which exhibits superior electrical properties and high ion transport number in the intermediate-to-low temperature ranges, as an electrolyte has been developed.

The protonic ceramic fuel cell (PCFC) has a structure in which porous anode (fuel electrode) and cathode (air electrode) are disposed with a gas-impermeable electrolyte layer of a dense structure therebetween. A fuel such as hydrogen is supplied to the anode, where it is electrochemically oxidized and separated into hydrogen ions (protons) and electrons. The electrons flow to the cathode via an external circuit and the protons pass through the electrolyte layer and reach the cathode. At the cathode, the protons and the electrons react with oxygen to produce water and electrical energy is generated using the potential difference between the cathode and the anode.

There are many problems to be solved for commercialization of the protonic ceramic fuel cell (PCFC). One of them is to improve the sintering behavior of the proton conductor for use as the electrolyte of the solid oxide fuel cell.

Yttrium-doped barium zirconate (BZY) has attracted a lot of attention in that it has a lower activation energy than an oxygen ion conductor because it conducts the relatively light and small hydrogen ions and exhibits high ion conductivity in the intermediate-to-low operating temperatures of 600-400° C. and is widely used as an electrolyte material of the protonic ceramic fuel cell (PCFC). However, yttrium-doped barium zirconate (BZY) requires a high sintering temperature of 1,700° C. or higher, where the constituents of the electrolyte such as barium (Ba) are volatilized, resulting in decline of electrical properties, and the cell performance is deteriorated due to a reaction with electrode components (patent document 1).

A method of using yttrium-doped barium cerate (BCY) as the material of the electrolyte layer instead of BZY has been proposed to lower the sintering temperature. However, because BCY is chemically unstable, it is very vulnerable to a fuel containing water or H₂O produced as a result of fuel cell reaction during the operation of the fuel cell and is easily decomposed under an acidic gas atmosphere including CO₂.

Also, a method of lowering the sintering temperature by adding copper oxide, zinc oxide, etc. to the proton conductor as a sintering aid has been proposed. However, it is problematic in that the electrical properties of the electrolyte decline due to the sintering aid and the sintering temperature is still high at 1,500° C. or higher.

As another method, yttrium-doped barium cerate-zirconate (BCZY) has been developed as a hybrid of BZY and BCY. However, there still remain the problems of difficulty in synthesis of a single-phase powder, high sintering temperature, etc.

As described above, the protonic ceramic fuel cell (PCFC) has a structure in which an anode (fuel electrode), an electrolyte layer and a cathode (air electrode) are stacked sequentially. When a cathode is sintered after it is formed on an electrolyte substrate in which an anode and an electrolyte layer are stacked, peeling occurs frequently at the interface of the electrolyte layer and the cathode due to asymmetric contraction caused by constrained sintering. Additionally, when a high-temperature process is employed to achieve sufficient interfacial bonding, a secondary phase may be produced as a result of chemical reaction between the electrolyte layer and the cathode and interphase material transport may occur. As a result, interfacial resistance may increase and the electrode characteristics of the cathode may be deteriorated.

As described above, the limitations of the existing process including the side effect of addition of the sintering aid for densification of the electrolyte, difficulty in forming the cathode layer, etc. make the commercialization of the protonic ceramic fuel cell (PCFC) difficult. Accordingly, development of a ground-breaking and commercially viable manufacturing method capable of solving these problems is necessary.

### SUMMARY

The present invention has been made to solve the problems described above and is directed to providing a method for forming a dense electrolyte layer without deterioration of electrical properties.

The present invention is also directed to providing a method for preparing a protonic ceramic fuel cell with superior interfacial bonding between an electrolyte layer and a cathode layer.

The present invention is also directed to providing a method for manufacturing a protonic ceramic fuel cell which is advantageous in area enlargement or mass production.

The purposes of the present invention are not limited to those described above. The features and aspects of the present invention will be apparent from the following detailed description and will be embodied by the means described in the claims and combinations thereof.

A method for manufacturing a protonic ceramic fuel cell according to the present invention may include: a step of synthesizing a sintering aid represented by Chemical Formula 1 or Chemical Formula 2; and a step of forming an electrolyte layer by adding the sintering aid to yttrium-doped barium cerate-zirconate (BCZY) and then sintering the same:

BaMO₂ [Chemical Formula 1]

BaY₂MO₅ [Chemical Formula 2]

wherein M is nickel (Ni), copper (Cu) or zinc (Zn).

In a specific exemplary embodiment of the present invention, the sintering aid may be added in an amount of 1-8 mol %.

In a specific exemplary embodiment of the present invention, the sintering may be conducted at 1,000-1,400° C.

The method for manufacturing a protonic ceramic fuel cell according to the present invention may include: a step of preparing an anode layer containing yttrium-doped barium cerate-zirconate (BCZY) and nickel oxide (NiO) as a transition metal oxide; a step of preparing an electrolyte paste by dispersing yttrium-doped barium cerate-zirconate (BCZY) in a solvent and forming an electrolyte layer by screen-printing the electrolyte paste on the anode layer; and a step of sintering the anode layer and the electrolyte layer at the same time.

In a specific exemplary embodiment of the present invention, the anode layer may be prepared by a step of mixing yttrium-doped barium cerate-zirconate (BCZY), nickel oxide (NiO) as a transition metal oxide and polymethyl methacrylate (PMMA) in a solvent, granulating the same by spray drying and forming an anode support layer by compressing the resulting granule and the electrolyte layer may be formed on the anode support layer.

In a specific exemplary embodiment of the present invention, the anode layer may be prepared by preparing an anode functional layer paste by mixing yttrium-doped barium cerate-zirconate (BCZY) and nickel oxide (NiO) as a transition metal oxide in a solvent and forming an anode functional layer by screen-printing the anode functional layer paste on the anode support layer and the electrolyte layer may be formed on the anode functional layer.

In a specific exemplary embodiment of the present invention, the transition metal oxide may include one or more of copper oxide (CuO) and zinc oxide (ZnO) or a combination thereof.

In a specific exemplary embodiment of the present invention, the electrolyte layer may not contain a sintering aid.

In a specific exemplary embodiment of the present invention, when the anode layer and the electrolyte layer are sintered at the same time, a sintering aid represented by Chemical Formula 1 or Chemical Formula 2 may be produced as the yttrium-doped barium cerate-zirconate (BCZY) and the transition metal oxide react in the anode layer:

BaMO₂ [Chemical Formula 1]

BaY₂MO₅ [Chemical Formula 2]

wherein M is nickel (Ni), copper (Cu) or zinc (Zn).

In a specific exemplary embodiment of the present invention, the sintering aid produced in the anode layer may be supplied to the electrolyte layer.

In a specific exemplary embodiment of the present invention, the yttrium-doped barium cerate-zirconate (BCZY) may be a powder with a diameter smaller than 1 μm.

In a specific exemplary embodiment of the present invention, the concurrent sintering temperature may be 1,000-1,450° C.

In a specific exemplary embodiment of the present invention, in the step of forming the anode support layer, the yttrium-doped barium cerate-zirconate (BCZY) and the transition metal oxide may be mixed at a mass ratio of 40:60 to 60:40.

In a specific exemplary embodiment of the present invention, in the step of forming the anode functional layer, the anode functional layer paste may be prepared by mixing the yttrium-doped barium cerate-zirconate (BCZY) and the transition metal oxide at a mass ratio of 40:60 to 60:40.

In a specific exemplary embodiment of the present invention, the method for manufacturing a protonic ceramic fuel cell may further include: a step of preparing a cathode paste by dispersing barium-strontium cobalt ferrite (BSCF) in a solvent and forming an interfacial bonding layer by screen-printing the cathode paste on the electrolyte layer; a step of microwave-sintering the interfacial bonding layer at 700-800° C.; a step of forming a cathode functional layer by screen-printing the cathode paste on the interfacial bonding layer; and a step of microwave-sintering the cathode functional layer at 600-700° C.

In a specific exemplary embodiment of the present invention, the yttrium-doped barium cerate-zirconate (BCZY) may be prepared by: a step of mixing a barium source, a cerium source, a zirconia source and an yttrium source; a step of calcining the mixture firstly at 1,100-1,300° C.; and a step of calcining the mixture secondly at 1,400-1,500° C.

In a specific exemplary embodiment of the present invention, the yttrium-doped barium cerate-zirconate (BCZY) may be a compound represented by Chemical Formula 3:

BaCe_{0.85-x}ZrₓY_{0.15}O_{3-δ} [Chemical Formula 3]

wherein x is from 0.1 to 0.7 and δ is from 0.075 to 0.235.

In a specific exemplary embodiment of the present invention, the barium source may be BaCO₃, the cerium may be is CeO₂, the zirconia source may be ZrO₂ and the yttrium source may be Y₂O₃.

The present invention may provide the following advantages effects.

According to the present invention, a dense electrolyte layer may be formed while maintaining the effect of facilitating sintering without deterioration of electrical properties due to the loss of the components of the electrolyte layer unlike the existing method of adding a transition metal sintering aid.

Also, according to the present invention, because a sintering aid is supplied indirectly from the anode layer to the electrolyte layer,

the sintering aid may be added at an optimized amount. Accordingly, deterioration of electrical properties due to the residual sintering aid may be prevented.

Also, according to the present invention, process convenience can be greatly improved because an optimal amount of a sintering aid can be supplied to the electrolyte layer easily without the need of complicated calculation or design.

Also, according to the present invention, the area enlargement and mass production of a protonic ceramic fuel cell can be achieved because a dense electrolyte layer can be formed simply by screen printing, rather than by a complicated process such as pressing, etc.

Also, according to the present invention, interfacial resistance and polarization are reduced because of superior interfacial bonding between the electrolyte layer and the cathode layer. Accordingly, a protonic ceramic fuel cell with excellent performance can be provided because power density is remarkably improved.

The effects of the present invention are not limited to those described above. It is to be understood that all the effects that can be inferred from the following description are included in the scope of the present invention.

### BRIEF DESCRIPTION OF DRAWINGS

FIG. 1 schematically illustrates a method for synthesizing yttrium-doped barium cerate-zirconate (BCZY) according to the present invention.

FIGS. 2a-2b show the X-ray diffraction analysis results of yttrium-doped barium cerate-zirconate (BCZY) synthesized according to the present invention. Specifically, FIG. 2 a shows a result obtained after first calcination and FIG. 2 b shows a result obtained after second calcination.

FIG. 3 shows a protonic ceramic fuel cell manufactured according to an exemplary embodiment of the present invention.

FIGS. 4a-4b show results of conducting scanning electron microscopy (SEM) analysis of electrolyte layers of Example 1 and Comparative Example 2 in Test Example 1. Specifically, FIG. 4 a shows a result for Comparative Example 2 and FIG. 4 b shows a result for Example 1.

FIG. 5 shows a result of measuring the electrical conductivity of electrolyte layers of Example 1 and Comparative Example 1 in Test Example 2.

FIG. 6 shows a result of measuring the electrical conductivity of electrolyte layers of Examples 1-3 in Test Example 3.

FIG. 7 shows a protonic ceramic fuel cell manufactured according to another exemplary embodiment of the present invention.

FIG. 8 illustrates the movement of a sintering aid in a protonic ceramic fuel cell manufactured according to another exemplary embodiment of the present invention.

FIG. 9 illustrates an anode support layer of a protonic ceramic fuel cell manufactured according to another exemplary embodiment of the present invention.

FIG. 10 illustrates an anode support layer and an anode functional layer of a protonic ceramic fuel cell manufactured according to another exemplary embodiment of the present invention.

FIG. 11 shows a result of granulating the source material of an anode support layer by spray drying in Example 4.

FIG. 12 shows a result of measuring the change in particle size distribution of an yttrium-doped barium cerate-zirconate (BCZY) powder prepared in Preparation Example 2 depending on milling time.

FIG. 13 shows an image of an anode electrolyte substrate prepared in Example 5.

FIGS. 14a-14b show results of analyzing the surface (electrolyte layer) microstructure of anode electrolyte substrates prepared in Example 5 and Comparative Example 4 by scanning electron microscopy (SEM) in Test Example 4. Specifically, FIG. 14 a shows a result for Comparative Example 4 and FIG. 14 b shows a result for Example 5.

FIG. 15 shows a protonic ceramic fuel cell manufactured according to still another exemplary embodiment of the present invention.

FIG. 16 shows an image of a unit cell manufactured in Example 6.

FIG. 17 shows a result of analyzing the cross section of a unit cell of Example 6 by scanning electron microscopy (SEM) in Test Example 5.

FIG. 18 shows a result of analyzing the surface of a cathode layer of Comparative Example 5 by scanning electron microscopy (SEM) in Test Example 5.

FIG. 19 shows a result of measuring the power density of unit cells of Example 6 and Comparative Example 5 in Test Example 6.

FIG. 20 shows a result of measuring the impedance of unit cells of Example 6 and Comparative Example 5 in Test Example 7.

FIG. 21 shows a result of evaluating the performance of a unit cell of Example 6 in Test Example 8.

### DETAILED DESCRIPTION

Hereinafter, the present invention is described in detail through examples. The examples of the present invention may be modified into various forms unless the gist of the invention is changed. However, the scope of the present invention is not limited by the examples.

The description about well-known features will be omitted to avoid unnecessarily obscuring the gist of the present invention. In the present invention, “include” or “contain” means that there may exist another component unless specified otherwise.

The present invention relates to a protonic ceramic fuel cell using yttrium-doped barium cerate-zirconate (BCZY) as an electrolyte material.

The yttrium-doped barium cerate-zirconate (BCZY) exhibits increased chemical stability under CO₂ and H₂O atmospheres as the amount of zirconium (Zr) increases but electrical conductivity and sintering behavior declines. Therefore, in the present invention, the composition of the yttrium-doped barium cerate-zirconate (BCZY) is selected as described below to balance the chemical stability and the electrical conductivity.

BaCe_{0.85-x}ZrₓY_{0.15}O_{3-δ}

wherein x is from 0.1 to 0.7 and δ is from 0.075 to 0.235.

For barium cerate-zirconate (BCZ) to have proton conductivity, an oxygen vacancy for hydration is necessary. For this, the oxygen vacancy is produced by replacing the tetravalent zirconium (Zr) or cerium (Ce) with a trivalent element such as yttrium, etc. The delta (δ) value is determined depending on the amount of the replaced yttrium, the amount of yttrium and a transition metal contained in a sintering aid, etc. Specifically, it may be from 0.075 to 0.235.

When preparing the yttrium-doped barium cerate-zirconate (BCZY), if a source material such as a barium source remains unreacted and an electrolyte layer and an anode functional layer are formed using the same, side reactions may occur between the unreacted material and other compounds, thereby leading to deteriorated electrical and chemical properties.

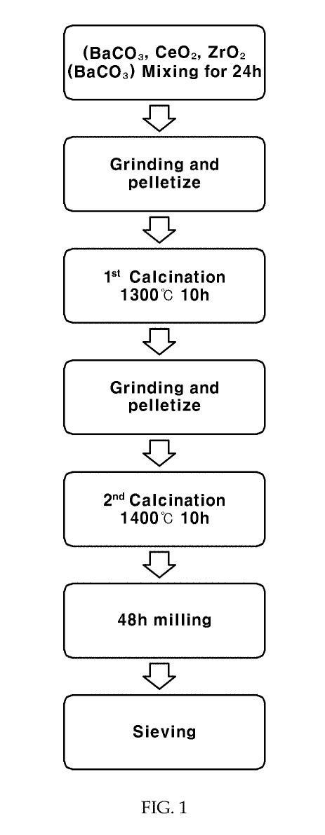

Accordingly, in the present invention, the yttrium-doped barium cerate-zirconate (BCZY) is synthesized by a method illustrated in FIG. 1 to remove the unreacted phase and increase purity.

Specifically, the yttrium-doped barium cerate-zirconate (BCZY) may be prepared by a step of mixing a barium source, a cerium source, a zirconia source and an yttrium source, a step of calcining the mixture firstly at 1,100-1,300° C. and a step of calcining the mixture secondly at 1,400-1,500° C.

Hereinafter, a specific exemplary embodiment of preparing the yttrium-doped barium cerate-zirconate (BCZY) is described.

BaCO₃ was used as a barium source. CeO₂ was used as a cerium source. ZrO₂ was used as a zirconia source. And, Y₂O₃ was used as an yttrium source. The source materials were dried in an oven at 200° C. for about 24 hours to remove water and organic materials.

After preparing the source materials by weighing such that x is 0.1, 0.3, 0.5 and 0.7 and adding ethanol and a dispersing agent, ball milling was conducted with a 5-pi zirconia ball for about 24 hours. The mixture was recovered and dried at 120° C. to remove ethanol. After preparing a sample by compressing the mixture was in a 35-pi mold with a pressure of about 20 MPa, the sample was calcined firstly at about 1,300° C. for about 10 hours. After preparing the sample into a powder, a sample was prepared by compressing again with the same method. The sample was calcined secondly at about 1,400° C. for about 10 hours. The calcined sample was mixed with ethanol and a dispersing agent, ball-milled with a 3-pi zirconia ball for about 48 hours and then dried and sieved through a 150-μm sieve to obtain an yttrium-doped barium cerate-zirconate (BCZY) powder.

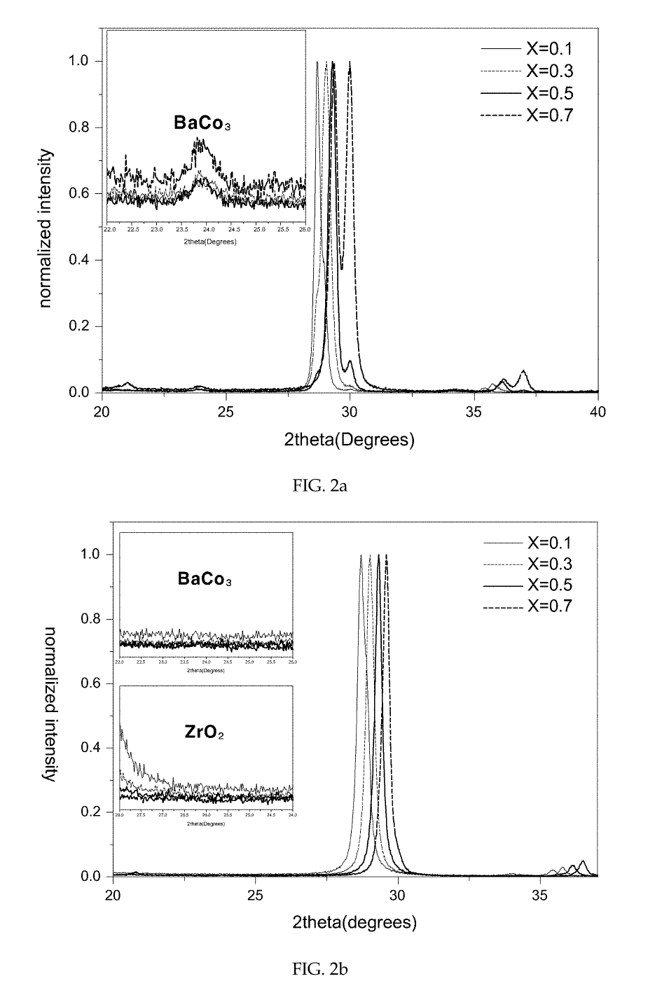

FIGS. 2a-2b show X-ray diffraction analysis results of the yttrium-doped barium cerate-zirconate (BCZY). Specifically, FIG. 2 a shows a result obtained after the first calcination and FIG. 2 b shows a result obtained after the second calcination.

Referring to FIG. 2 a, it can be seen that unreacted barium source (BaCO₃) exists after the first calcination. But, referring to FIG. 2 b, it can be seen that the unreacted phase has been removed completely after the first calcination and the second calcination were conducted.

Accordingly, high-purity yttrium-doped barium cerate-zirconate (BCZY) with no unreacted phase can be prepared according to the present invention.

### An Exemplary Embodiment of the Present Invention is as Follows

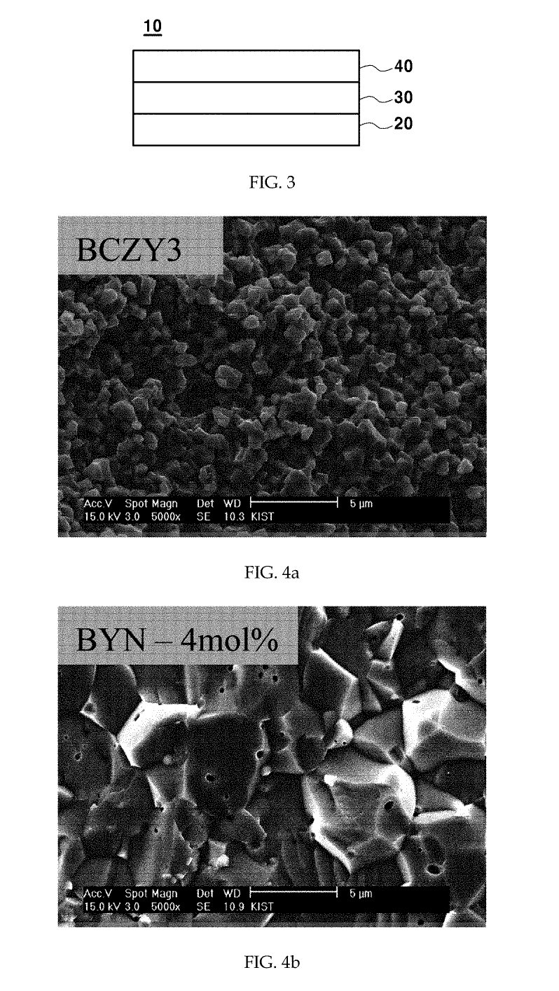

FIG. 3 shows a protonic ceramic fuel cell manufactured according to an exemplary embodiment of the present invention. The protonic ceramic fuel cell 10 contains an anode layer 20, electrolyte layer 30 formed on the anode layer and a cathode layer 40 formed on the electrolyte layer.

A method for manufacturing a protonic ceramic fuel cell according to an exemplary embodiment of the present invention may include a step of synthesizing a sintering aid represented by Chemical Formula 1 or Chemical Formula 2 and a step of forming an electrolyte layer by adding the sintering aid to yttrium-doped barium cerate-zirconate (BCZY) and then sintering the same:

BaMO₂ [Chemical Formula 1]

BaY₂MO₅ [Chemical Formula 2]

wherein M is nickel (Ni), copper (Cu) or zinc (Zn).

Formerly, transition metal oxides such as nickel oxide (NiO), copper oxide (CuO), zinc oxide (ZnO), etc. have been used as a sintering aid for forming a dense electrolyte layer.

The transition metal oxide itself does not act as a sintering aid. The transition metal oxide reacts with the barium (Ba), yttrium (Y) of yttrium-doped barium cerate-zirconate (BCZY) as follows. For the convenience of explanation, suppose that nickel oxide (NiO) is used as the transition metal oxide.

BCZY+NiO→B_{(1-x-y)}CZY_{(1-2y)}+xBaNiO₂+yBaY₂NiO₅+(1-x-y)NiO

The BaNiO₂ and BaY₂NiO₅ produced from the reaction of nickel oxide (NiO) and yttrium-doped barium cerate-zirconate (BCZY) facilitate the sintering of the yttrium-doped barium cerate-zirconate (BCZY).

That is to say, when the transition metal oxide is added as a sintering aid, the electrical properties of the electrolyte layer are deteriorated because the barium (Ba) and yttrium (Y) of the yttrium-doped barium cerate-zirconate (BCZY) are consumed.

The inventors of the present invention aimed at maintaining the effect of facilitating sintering without deterioration of the electrical properties of the electrolyte layer, based on the fact that the transition metal oxide does not directly act as a sintering aid but the reaction product of the transition metal oxide and the electrolyte material acts as a sintering aid, by separately synthesizing the product and directly adding to the electrolyte material.

Accordingly, according to the present invention, the compound represented by Chemical Formula 1 or Chemical Formula 2, which is the reaction product of the transition metal oxide and the yttrium-doped barium cerate-zirconate (BCZY), is synthesized and then added to the yttrium-doped barium cerate-zirconate (BCZY) as a sintering aid, and then sintering is conducted to form an electrolyte layer.

### Preparation Example—Synthesis of Sintering Aid

A sintering aid represented by the chemical formula BaY₂NiO₅ was synthesized by solid-phase synthesis. First, BaCO₃, NiO and Y₂O₃ powders were prepared by drying in an oven at 200° C. The powders were adequately weighed and mixed to satisfy the appropriate composition ratio of chemical formula BaY₂NiO₅. After adding ethanol and a dispersing agent to the mixed powders, ball milling was conducted with a 5-pi zirconia ball for 24 hours. The mixture was dried at 120° C. to remove ethanol. Then, a sintering aid was synthesized by calcining at 1,100° C. for 5 hours. After adding ethanol and a dispersing agent again, the sintering aid was ball-milled with a 3-pi zirconia ball for 24 hours and then dried.

### Example 1—Formation of Electrolyte Layer

The sintering aid synthesized in Preparation Example was added to yttrium-doped barium cerate-zirconate (BCZY) at a content of 4 mol % and then mixed by ball milling. The mixed powder was added to a 10-pi mold and an electrolyte layer was formed by compressing at a pressure of 100 MPa. The electrolyte layer was sintered at 1,350° C. for 4 hours to obtain a sample according to Example 1.

The sintering temperature may be 1,000-1,400° C., specifically 1,100-1,350° C., more specifically 1,200-1,350° C., further more specifically 1,350° C. When the sintering temperature is lower than 1,000° C., densification of the electrolyte layer may not occur. Additionally, when it is higher than 1,400° C., the components of the electrolyte layer and the anode layer or the cathode layer and the electrolyte layer may react with each other or deterioration may occur.

### Example 2

An electrolyte layer was formed in the same manner as in Example 1, except that the synthesized sintering aid in Preparation Example was added at a content of 1 mol %.

### Example 3

An electrolyte layer was formed in the same manner as in Example 1, except that the synthesized sintering aid in Preparation Example was added at a content of 8 mol %.

### Comparative Example 1

An electrolyte layer was formed in the same manner as in Example 1, except that nickel oxide (NiO) was used as a sintering aid and the nickel oxide (NiO) was added at a content of 4 mol %.

### Comparative Example 2

An electrolyte layer was formed only with yttrium-doped barium cerate-zirconate (BCZY) without adding any compound acting as a sintering aid, formed in the same manner as in Example 1.

### Test Example 1—Scanning Electron Microscopy (SEM) Analysis

Scanning electron microscopy (SEM) analysis was conducted for the electrolyte layers of Example 1 and Comparative Example 2. The results are shown in FIGS. 4a-4b. Specifically, FIG. 4 a shows a result for Comparative Example 2 and FIG. 4 b shows a result for Example 1.

Referring to FIG. 4 a, it can be seen that the densification of yttrium-doped barium cerate-zirconate (BCZY) did not occur at all in the electrolyte layer of Comparative Example 2 with no sintering aid added.

Referring to FIG. 4 b, it can be seen that the densification and particle growth of yttrium-doped barium cerate-zirconate (BCZY) were facilitated when the sintering aid represented by the chemical formula BaY₂NiO₅ was added like when the existing transition metal oxide was added as a sintering aid. Accordingly, it was confirmed that an electrolyte layer with a dense structure can be formed according to an exemplary embodiment of the present invention.

### Test Example 2—Measurement of Electrical Conductivity

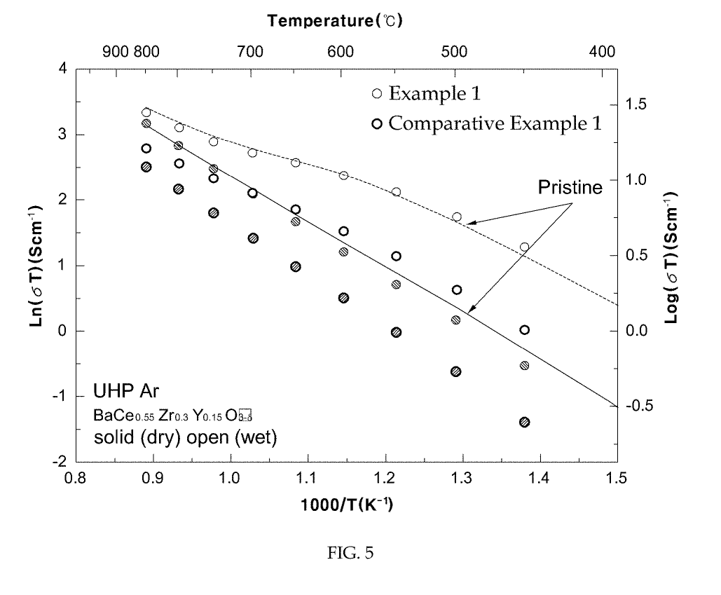

After constructing an electrode on a sample (electrolyte layer) of Example 1 or Comparative Example 1 with a platinum wire and a paste, electrical conductivity was measured while lowering temperature from 850° C. to 450° C. at 50° C. intervals. The electrical conductivity was measured by the DC 4-probe method under dry and wet argon atmospheres. Under each temperature condition, the electrical conductivity was measured after waiting sufficiently for stabilization. The result is shown in FIG. 5. For comparison, the electrical conductivity of the sample prepared by sintering yttrium-doped barium cerate-zirconate (BCZY) at a high temperature of 1700° C. for 10 hours (Comparative Example 3) was displayed with solid (dry condition) and broken (wet condition) lines.

Referring to FIG. 5, it can be seen that, although dense electrolyte layers could be obtained at low sintering temperature by adding the specific sintering aids in Example 1 and Comparative Example 1, they show significant difference in electrical properties. When nickel oxide (NiO) was used as the sintering aid (Comparative Example 1), the electrical conductivity was significantly decreased under both dry (solid circles) and wet (open circles) conditions. In contrast, when the sintering aid represented by the chemical formula BaY₂NiO was used (Example 1), the electrical conductivity was comparable to that of Comparative Example 3.

### Test Example 3—Measurement of Electrical Conductivity Depending on Addition Amount of Sintering Aid

The electrical conductivity of the samples of Examples 1-3 was measured in the same manner as in Test Example 2. The result is shown in FIG. 6.

Referring to FIG. 6, it can be seen that, although the electrical conductivity was decreased slightly as the content of the sintering aid represented by the chemical formula BaY₂NiO was increased, an electrical conductivity comparable to that of Comparative Example 3 was observed when the content of the sintering aid was in a range from 1 to 8 mol %.

### Another Exemplary Embodiment of the Present Invention is as Follows

In another exemplary embodiment of the present invention, the sintering aid represented by Chemical Formula 1 or Chemical Formula 2 is added to the yttrium-doped barium cerate-zirconate (BCZY) constituting the electrolyte layer not directly but indirectly.

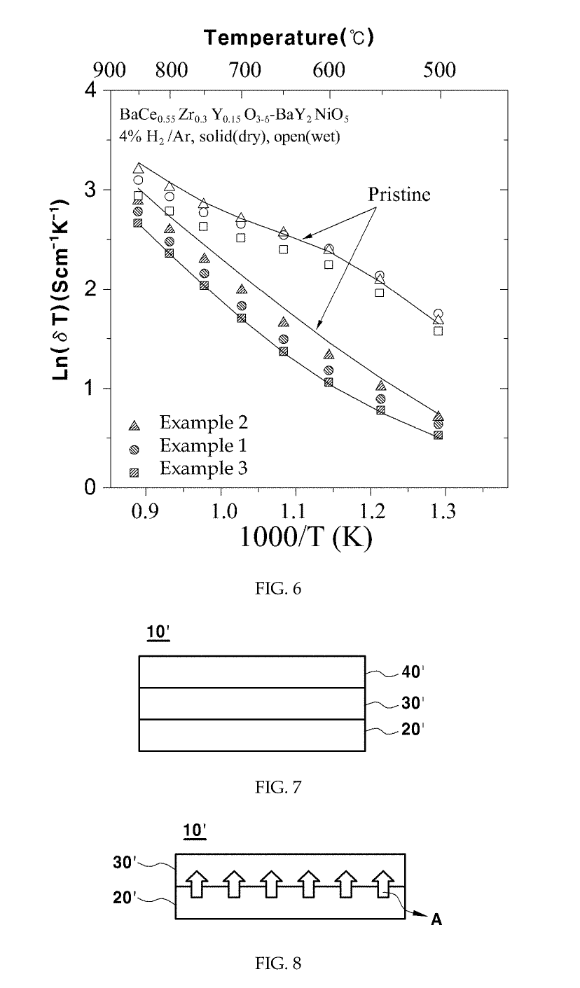

FIG. 7 shows a protonic ceramic fuel cell manufactured according to another exemplary embodiment of the present invention. The protonic ceramic fuel cell 10′ contains an anode layer 20′, an electrolyte layer 30′ formed on the anode layer 20′ and a cathode layer 40′ formed on the electrolyte layer.

A method for manufacturing a protonic ceramic fuel cell according to another exemplary embodiment of the present invention includes a step of preparing an anode layer containing yttrium-doped barium cerate-zirconate (BCZY) and nickel oxide (NiO) as a transition metal oxide, a step of preparing an electrolyte paste by dispersing yttrium-doped barium cerate-zirconate (BCZY) in a solvent and forming an electrolyte layer by screen-printing the electrolyte paste on the anode layer and a step of sintering the anode layer and the electrolyte layer at the same time. The transition metal oxide may include one or more of copper oxide (CuO) and zinc oxide (ZnO) in addition to the nickel oxide (NiO) or a combination thereof.

More specifically, when the anode layer and the electrolyte layer are sintered at the same time, the sintering aid represented by Chemical Formula 1 or Chemical Formula 2 is produced in the anode layer as the yttrium-doped barium cerate-zirconate (BCZY) reacts with the transition metal oxide and, as shown in FIG. 8, the sintering aid produced in the anode layer 20′ is diffused and supplied (A) to the electrolyte layer 30′. As a result, the sintering of the yttrium-doped barium cerate-zirconate (BCZY) constituting the electrolyte layer 30′ is facilitated.

As described above, when the sintering aid represented by Chemical Formula 1 or Chemical Formula 2 is synthesized separately and then added to the yttrium-doped barium cerate-zirconate (BCZY) constituting the electrolyte layer, it is difficult to determine the optimal addition amount of the sintering aid. It is because the residual sintering aid may deteriorate the physical properties of the cell.

In contrast, according to another exemplary embodiment of the present invention, because the sintering aid self-produced in the anode layer is naturally diffused to the electrolyte layer, the sintering aid may be supplied in an optimal amount necessary for facilitating the sintering of the yttrium-doped barium cerate-zirconate (BCZY) constituting the electrolyte layer. Accordingly, there is no concern of decline in electrical conductivity and chemical stability caused by the residual sintering aid and the process convenience is improved because it is not necessary to directly synthesize the sintering aid and mix with the yttrium-doped barium cerate-zirconate (BCZY) by ball milling, etc.

According to another exemplary embodiment of the present invention, because the yttrium-doped barium cerate-zirconate (BCZY) and the transition metal oxide react in the anode layer, the electrical properties of the yttrium-doped barium cerate-zirconate (BCZY) constituting the anode layer are deteriorated. But, because the anode layer simply serves the function of structural support rather than as an ion conductor, unlike the electrolyte layer, it is not a severe problem. Specifically, because the supply of a fuel and the transport of an electron to the anode layer are undertaken by a porous structure or a metal (Cu, Ni, Zn, etc.), the decline in the electrical conductivity of the yttrium-doped barium cerate-zirconate (BCZY) constituting the anode layer does not significantly affect the cell performance.

According to another exemplary embodiment of the present invention, because the sintering aid represented by Chemical Formula 1 or Chemical Formula 2 can be supplied from the anode layer to the electrolyte layer in an amount sufficient for densification as described above, a process for increasing the degree of densification such as pressing, etc. is unnecessary. That is to say, because densification is well achieved during the sintering even when the electrolyte layer is formed by a simple method such as screen printing, etc., it may be greatly advantageous in area enlargement and mass production of a protonic ceramic fuel cell.

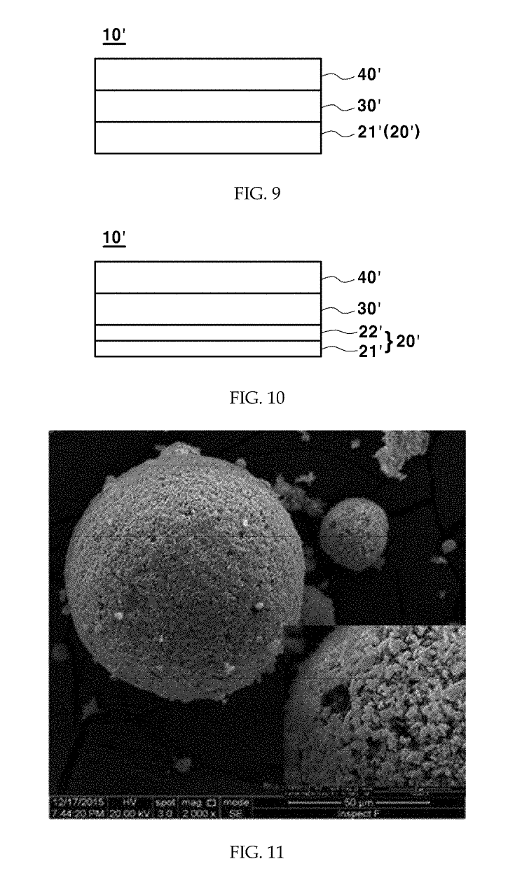

In the protonic ceramic fuel cell according to another exemplary embodiment of the present invention, the anode layer 20′ may be an anode support layer 21′ as shown in FIG. 9 or the anode layer 20′ may include an anode support layer 21′ and an anode functional layer 22′ as shown in FIG. 10.

The anode layer of the protonic ceramic fuel cell shown in FIG. 9 may be prepared by a step of mixing yttrium-doped barium cerate-zirconate (BCZY), nickel oxide (NiO) as a transition metal oxide and polymethyl methacrylate (PMMA) in a solvent, granulating the same by spray drying and forming an anode support layer by compressing the resulting granule.

The polymethyl methacrylate is used to make the anode support layer porous. Therefore, the anode support layer may serve to supply a fuel as well as to provide structural support.

The anode layer of the protonic ceramic fuel cell shown in FIG. 10 may be prepared by a step of mixing yttrium-doped barium cerate-zirconate (BCZY), nickel oxide (NiO) as a transition metal oxide and polymethyl methacrylate (PMMA) in a solvent, granulating the same by spray drying and forming an anode support layer by compressing the resulting granule and a step of preparing an anode functional layer paste by mixing yttrium-doped barium cerate-zirconate (BCZY) and nickel oxide (NiO) as a transition metal oxide in a solvent and forming an anode functional layer by screen-printing the anode functional layer paste on the anode support layer.

The anode functional layer prevents the structural defect of the electrolyte layer by decreasing the surface defects of the anode layer and decreases the polarization resistance of the protonic ceramic fuel cell by providing a porous structure with an increased pore size to the anode support layer. Through this, the performance of the fuel cell may be improved.

The anode support layer may be formed to a thickness of 1,500 μm or smaller, specifically 1,000 μm or smaller, more specifically 800 μm or smaller, although not being limited thereto.

Additionally, the anode functional layer may be formed to a thickness of 30 μm or smaller, specifically 20 μm or smaller, more specifically 15 μm or smaller, although not being limited thereto.

The electrolyte layer may be formed by screen printing to a thickness of 20 μm or smaller, specifically 15 μm or smaller, more specifically 10 μm or smaller, although not being limited thereto.

The anode layer and the electrolyte layer may be sintered at the same time at a temperature of 1,000-1,450° C., specifically 1,100-1,350° C., more specifically 1,200-1,350° C., further more specifically 1,350° C. When the sintering temperature is lower than 1,000° C., densification of the electrolyte layer may not occur. Additionally, when it is higher than 1,450° C., the cell performance may be deteriorated due to decline in physical properties, increase in interfacial resistance and deterioration of electrode microstructure caused by high-temperature reactions between the electrolyte and electrode.

### Example 4—Formation of Anode Support Layer

84.74 g of yttrium-doped barium cerate-zirconate (BCZY), 103.87 g of nickel oxide (NiO) and 14.58 g of polymethyl methacrylate (PMMA) were mixed in a solvent. In order to improve binding between the components, a small amount of polymer binder was added.

The polymethyl methacrylate (PMMA), which is for ensuring pores inside the anode support layer, had a diameter of about 5 μm and was added to about 30% of the total volume. As the solvent, ethanol was used and was added in an amount such that a solid content was about 20%.

The obtained mixture was granulated by spray drying. The spray drying is a process for preparing a granule by spraying a suspension containing a mixture of a specific ratio at high temperature to remove a solvent while maintaining the dispersed state of the mixture and granules of various sizes can be prepared by controlling the process conditions. FIG. 11 is an image showing the microstructure of the granule of the mixture obtained by spray drying. Referring to the figure, it can be seen that the mixture of yttrium-doped barium cerate-zirconate (BCZY), nickel oxide (NiO) and polymethyl methacrylate (PMMA) is granulated adequately. A spherical granule was formed during the suspension spraying and evaporation processes due to the surface tension of the solvent.

An anode support layer was completed by compressing the granule in a 8×8 cm² mold at a pressure of 80 MPa and then heating (annealing) at 200° C. for about 24 hours.

### Preparation Example 2—Control of Diameter of BCZY Powder

Before forming an anode functional layer and an electrolyte layer on the anode support layer, the diameter of the yttrium-doped barium cerate-zirconate (BCZY) powder was controlled for easier screen printing. For screen printing, it is necessary to prepare a paste. If the yttrium-doped barium cerate-zirconate (BCZY) has a broad particle size distribution or aggregates or coarse particles exist, dispersion and viscosity control may be difficult during the preparation of the paste. In addition, because they may cause nonuniform sintering behavior of the screen-printed electrolyte layer or defects such as residual pores after screen printing, it is necessary to control the diameter carefully.

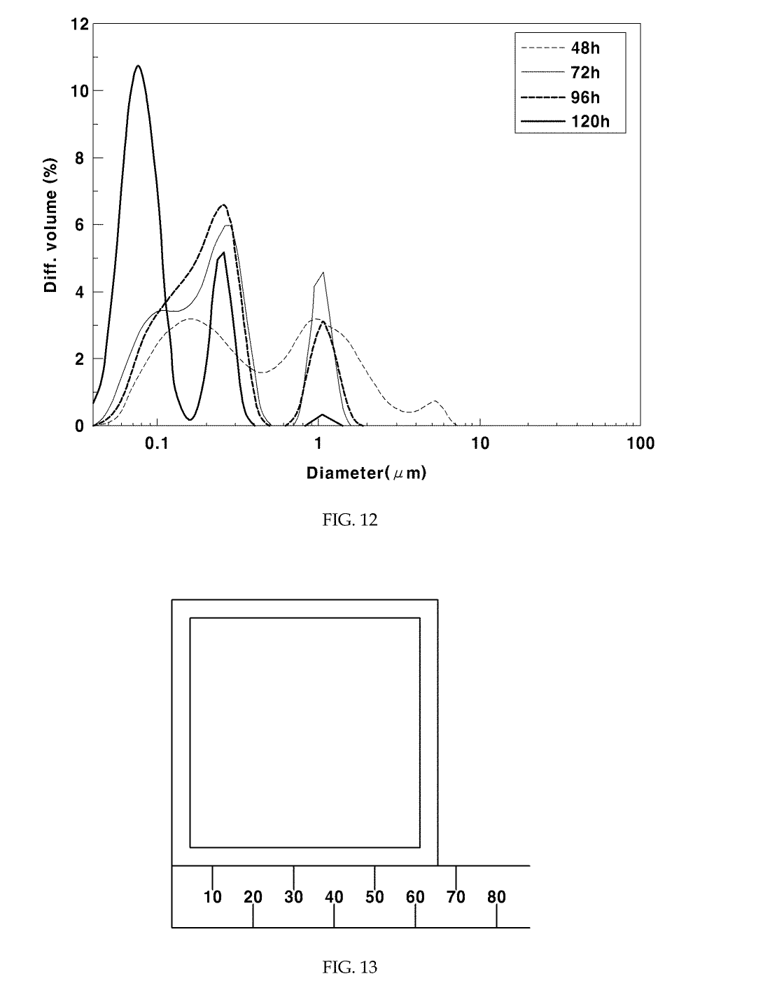

After adding ethanol and a dispersing agent to the synthesized yttrium-doped barium cerate-zirconate (BCZY) powder, the mixture was ball-milled with a 3-pi zirconia ball. FIG. 12 shows a result of measuring the change in particle size distribution of the yttrium-doped barium cerate-zirconate (BCZY) powder depending on milling time.

Referring to the figure, it can be seen that the amount of a powder with a diameter of 1 μm or larger is minimized when ball milling was conducted for 120 hours. As a result, yttrium-doped barium cerate-zirconate (BCZY) with a diameter smaller than 1 μm was obtained and an anode functional layer and an electrolyte layer were formed using the same as described below.

### Example 5—Formation of Anode Functional Layer and Electrolyte Layer

An anode functional layer paste was prepared by mixing 8.986 g of the yttrium-doped barium cerate-zirconate (BCZY) prepared in Preparation Example 2 and 11.014 g of nickel oxide (NiO) in a solvent.

The yttrium-doped barium cerate-zirconate (BCZY) and the transition metal oxide (nickel oxide in Example 5) may be mixed at a mass ratio from 40:60 to 60:40, specifically 45:55. Additionally, the volume ratio of the yttrium-doped barium cerate-zirconate (BCZY) and the nickel (Ni) element in the anode functional layer paste may be 6:4.

As solvent, α-terpineol having a high boiling point was used to enhance interfacial bonding between an anode functional layer and the anode support layer and to prevent defect formation during drying, and was added in such an amount that the solid content was about 15%.

An anode functional layer was formed by screen-printing the anode functional layer paste on the anode support layer formed in Example 4. After waiting for 30 minutes at room temperature until the printed anode functional layer formed a film, it was dried in ovens at 60° C. and 80° C. sequentially to remove the solvent. The screen printing of the anode functional layer paste and the drying were repeated until an anode functional layer of an adequate thickness was obtained.

An electrolyte paste was prepared by dispersing 20 g of the yttrium-doped barium cerate-zirconate (BCZY) of Preparation Example 2 in a solvent. As the solvent, α-terpineol was used for the same reason as described above and was added in such an amount that the solid content was about 14%.

An electrolyte layer was formed by screen-printing the electrolyte paste on the anode functional layer. After waiting for 30 minutes at room temperature until the printed electrolyte layer formed a film, it was dried in ovens at 60° C. and 80° C. sequentially to remove the solvent. The screen printing of the electrolyte paste and the drying were repeated until an electrolyte layer of an adequate thickness within 10 μm was obtained.

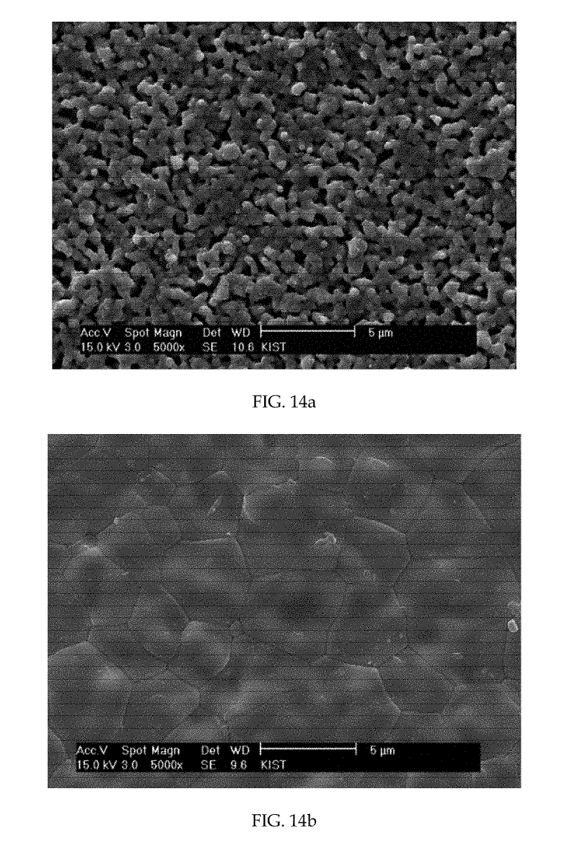

Then, the anode functional layer and the electrolyte layer were sintered at the same time at about 1,350° C. for about 4 hours. As a result, a substrate consisting of the anode support layer, the anode functional layer and the electrolyte layer was obtained. Hereinafter, this substrate is referred to as an anode electrolyte substrate. FIG. 13 shows an image of the anode electrolyte substrate.

### Comparative Example 4

An anode electrolyte substrate was prepared in the same manner as in Example 5, except that yttrium-doped stabilized zirconia (YSZ) was used instead of yttrium-doped barium cerate-zirconate (BCZY) in the preparation of the anode functional layer paste and the formation of the anode functional layer. The yttrium-doped stabilized zirconia (YSZ) does not produce the sintering aid represented by Chemical Formula 1 or Chemical Formula 2 by reacting with nickel oxide (NiO). Accordingly, it is predicted that a sintering aid would not have been supplied to the electrolyte layer during the sintering in Comparative Example 4.

### Test Example 4-Scanning Electron Microscopy (SEM) Analysis

The surface (electrolyte layer) microstructure of the anode electrolyte substrates of Example 5 and Comparative Example 4 was analyzed by scanning electron microscopy (SEM). The results are shown in FIGS. 14a-14b. Specifically, FIG. 14 a shows a result for Comparative Example 4 and FIG. 14 b shows a result for Example 5.

Referring to FIG. 14 a, it can be seen that the densification of the yttrium-doped barium cerate-zirconate (BCZY) did not occur at all in the electrolyte layer of Comparative Example 4. It is because the sintering aid represented by Chemical Formula 1 or Chemical Formula 2 was not supplied from the electrolyte layer to the anode layer in Comparative Example 4.

In contrast, referring to FIG. 14 b, it can be seen that a dense structure with a particle diameter of about 3-5 μm was formed even at low sintering temperature for the electrolyte layer of Example 5. This means that the sintering aid produced during the sintering was supplied from the anode layer (the anode support layer and the anode functional layer) to the electrolyte layer.

Therefore, according to another exemplary embodiment of the present invention, the sintering aid represented by Chemical Formula 1 or Chemical Formula 2 can be supplied indirectly from the anode layer to the electrolyte layer and, accordingly, there is no concern of decline in electrical conductivity and chemical stability caused by the residual sintering aid and the process convenience is improved because it is not necessary to directly synthesize the sintering aid and mix with the yttrium-doped barium cerate-zirconate (BCZY) by ball milling, etc.

### Still Another Exemplary Embodiment of the Present Invention is as Follows

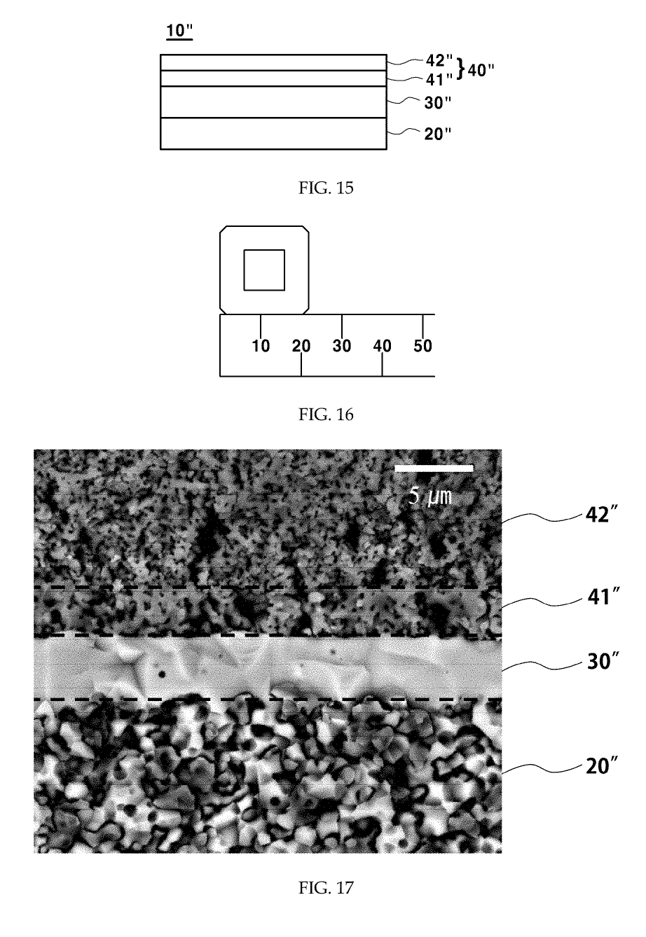

FIG. 15 shows a protonic ceramic fuel cell manufactured according to still another exemplary embodiment of the present invention. The protonic ceramic fuel cell 10″ includes an anode layer 20″, an electrolyte layer 30″ formed on the anode layer and a cathode layer 40″ formed on the electrolyte layer. The cathode layer 40″ may consist of an interfacial bonding layer 41″ which is for enhancing bonding with the electrolyte layer and forming a uniform interface and a cathode functional layer 42″ formed on the interfacial bonding layer where a cathode reaction occurs.

Formerly, a protonic ceramic fuel cell was manufactured by forming an anode electrolyte substrate consisting of an anode layer and an electrolyte layer, forming a single-layered cathode layer thereon and then conducting heat treatment at high temperature. However, the heat treatment at high temperature is problematic in that an interfacial reaction consuming the barium element may occur between the electrolyte layer and the cathode layer and it is difficult to resolve the trade-off problem of interfacial bonding between the electrolyte layer and the cathode layer and microstructure formation of the cathode.

In the present invention, in order to solve these problems, the cathode layer is functionally separated into two layers responsible for interfacial bonding and a cathode reaction, respectively, and the layers are microwave-sintered at low temperature, thereby remarkably reducing the heat treatment temperature and time.

Specifically, a method for manufacturing a protonic ceramic fuel cell according to still another exemplary embodiment of the present invention may include a step of preparing a cathode paste by dispersing barium-strontium cobalt ferrite (Ba_{0.5}Sr_{0.5}Co_{0.8}Fe_{0.2}O_{3-δ}, BSCF) in a solvent and forming an interfacial bonding layer by screen-printing the cathode paste on the electrolyte layer, a step of microwave-sintering the interfacial bonding layer at 700-800° C., specifically at 800° C., a step of forming a cathode functional layer by screen-printing the cathode paste on the interfacial bonding layer and a step of microwave-sintering the cathode functional layer at 600-700° C., specifically at 700° C.

### Example 6—Preparation of Double-Layered Cathode Layer

A cathode paste was prepared by dispersing 20 g of barium-strontium cobalt ferrite (BSCF) in an α-terpineol solvent. The solvent was added in such an amount that the solid content was about 15%.

An interfacial bonding layer was formed by screen-printing the cathode paste on the electrolyte layer of the anode electrolyte substrate prepared in Example 5 with an area of 1×1 cm². The interfacial bonding layer was microwave-sintered at about 800° C. for about 1 minute.

Although the cathode layer was formed on the anode electrolyte substrate of Example 5 (another exemplary embodiment of the present invention) in this example, the present invention is not necessarily limited thereto. Instead, it may be also formed on the electrolyte layer of Examples 1-3 (an exemplary embodiment of the present invention).

A cathode functional layer was formed by screen-printing the cathode paste on the interfacial bonding layer with the same area as described above. A double-layered cathode layer was completed by microwave-sintering the cathode functional layer at about 700° C. for about 1 minute. FIG. 16 shows an image of a unit cell to which the double-layered cathode layer was applied.

### Comparative Example 5

A cathode layer was prepared according to the existing method. Specifically, a cathode layer was prepared by forming the cathode paste on the electrolyte layer of the anode electrolyte substrate as a single layer and then heat treated at high temperature of about 950° C. for about 2 hours.

### Test Example 5—Scanning Electron Microscopy (SEM) Analysis

The cross section of the unit cell according to Example 6 was subjected to scanning electron microscopy (SEM) analysis. The result is shown in FIG. 17. Referring to the figure, it can be seen that an interface was formed uniformly between the electrolyte layer 30″ and the interfacial bonding layer 41″, and that the cathode functional layer 42″ has a well-defined microstructure.

The surface of the cathode layer prepared in Comparative Example 5 was analyzed by scanning electron microscopy (SEM). The result is shown in FIG. 18. Referring to the figure, it can be seen that, for Comparative Example 5, as a result of the high-temperature heat treatment for ensuring sufficient interfacial bonding between the electrolyte layer and the cathode layer, cracks occurred as the cathode layer was excessively sintered and contracted in the lengthwise direction.

### Test Example 6—Measurement of Power Density

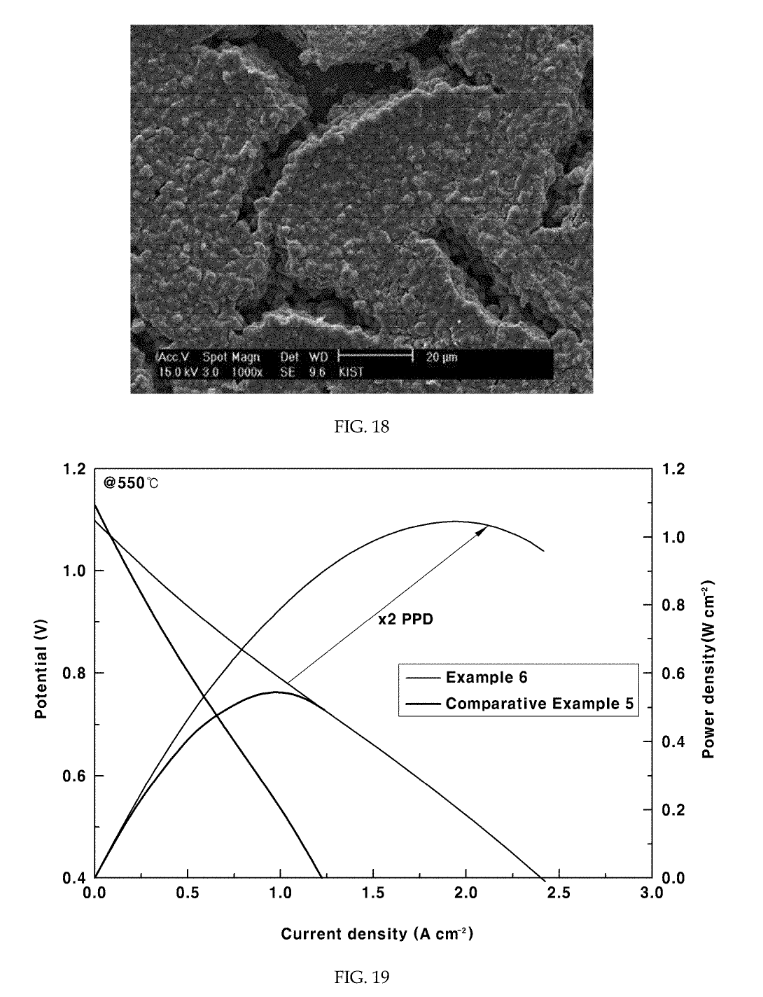

The power density of the unit cells according to Example 6 and Comparative Example 5 was measured. The result is shown in FIG. 19. Referring to the figure, it can be seen that Example 6 showed about 2 times improved peak power density (PPD) as compared to Comparative Example 5. It is thought as a result of inhibited interfacial reaction between the interfacial bonding layer and the electrolyte layer and improved microstructure of the cathode functional layer due to the low-temperature process.

### Test Example 7—Impedance Analysis

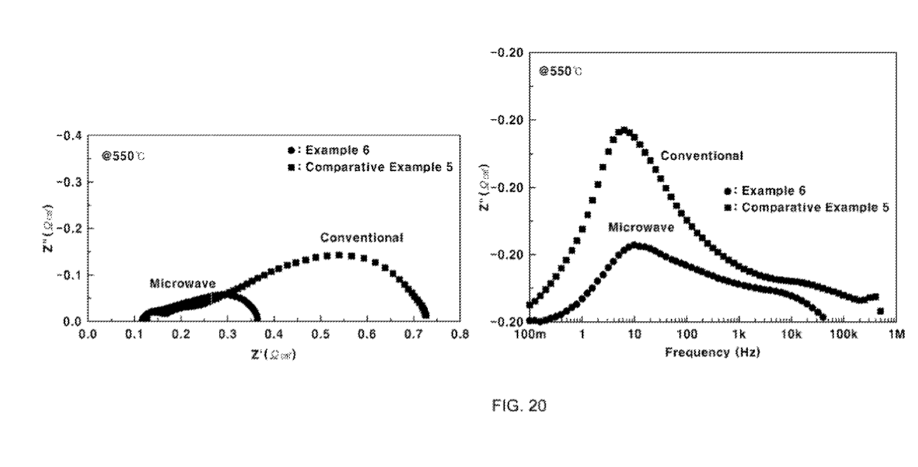

The impedance of the unit cells according to Example 6 and Comparative Example 5 was measured. The result is shown in FIG. 20. Referring to the figure, it can be seen that polarization phenomenon was remarkably decreased for Example 6 as compared to Comparative Example 5. It is also thought as a result of inhibited interfacial reaction between the interfacial bonding layer and the electrolyte layer, formation of a uniform interface and improved microstructure of the cathode functional layer due to the low-temperature process.

### Test Example 8—Evaluation of Unit Cell Performance

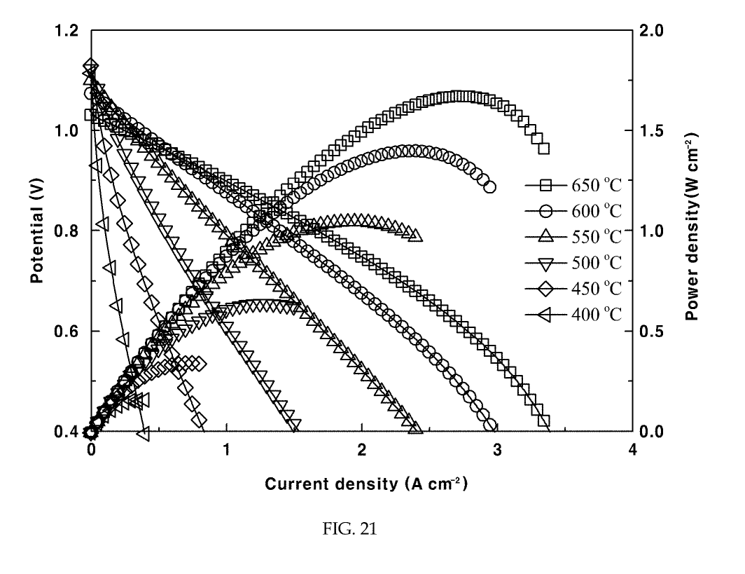

The performance of the unit cell according to Example 6 was evaluated in an intermediate-to-low operating temperature range (400-650° C.). The result is shown in FIG. 21. Referring to the figure, it can be seen that OCV was about 1.1 V at all temperature ranges, suggesting that the electrolyte layer is dense and gas leakage did not occur. Additionally, it can be seen that the peak power density reached about 1,800 mW/cm² at 650° C. Accordingly, it was confirmed that the protonic ceramic fuel cell manufactured according to the present invention exhibits superior cell performance in intermediate-to-low temperature ranges.

The present invention has been described in detail with reference to specific embodiments thereof. However, it will be appreciated by those skilled in the art that various changes and modifications may be made in these embodiments without departing from the principles and spirit of the invention, the scope of which is defined in the appended claims and their equivalents.

### DETAILED DESCRIPTION OF MAIN ELEMENTS

| | |
|---|---|
| 10, 10′, 10″: protonic ceramic fuel cell | |
| 20, 20′, 20″: anode layer | |
| 21′: anode support layer | 22′: anode functional layer |
| 30, 30′, 30″: electrolyte layer | |
| 40, 40″: cathode layer | |
| 41″: interfacial bonding layer | 42″: cathode functional layer |
| 50′: anode support layer | |

What is claimed is:

1. A method for manufacturing a protonic ceramic fuel cell, comprising:
synthesizing a sintering aid represented by Chemical Formula 1 or Chemical Formula 2; and forming an electrolyte layer by adding the sintering aid to yttrium-doped barium cerate-zirconate (BCZY) and then sintering the same:
BaMO₂ [Chemical Formula 1]
BaY₂MO₅ [Chemical Formula 2]
wherein M is nickel (Ni), copper (Cu) or zinc (Zn).

2. The method for manufacturing a protonic ceramic fuel cell according to claim 1, wherein the sintering aid is added in an amount of 1-8 mol %.

3. The method for manufacturing a protonic ceramic fuel cell according to claim 1, wherein the sintering is conducted at 1,000-1,400° C.

4. A method for manufacturing a protonic ceramic fuel cell, comprising:
preparing an anode layer comprising yttrium-doped barium cerate-zirconate (BCZY) and nickel oxide (NiO) as a transition metal oxide;
preparing an electrolyte paste by dispersing yttrium-doped barium cerate-zirconate (BCZY) in a solvent and forming an electrolyte layer by screen-printing the electrolyte paste on the anode layer; and
sintering the anode layer and the electrolyte layer at the same time.

5. The method for manufacturing a protonic ceramic fuel cell according to claim 4, wherein the anode layer is prepared by mixing yttrium-doped barium cerate-zirconate (BCZY), nickel oxide (NiO) as a transition metal oxide and polymethyl methacrylate (PMMA) in a solvent, granulating the same by spray drying and forming an anode support layer by compressing the resulting granule and the electrolyte layer is formed on the anode support layer.

6. The method for manufacturing a protonic ceramic fuel cell according to claim 5, wherein the anode layer is further prepared by preparing an anode functional layer paste by mixing yttrium-doped barium cerate-zirconate (BCZY) and nickel oxide (NiO) as a transition metal oxide in a solvent and forming an anode functional layer by screen-printing the anode functional layer paste on the anode support layer and the electrolyte layer is formed on the anode functional layer.

7. The method for manufacturing a protonic ceramic fuel cell according to claim 4, wherein the transition metal oxide comprises one or more of copper oxide (CuO) and zinc oxide (ZnO) or a combination thereof.

8. The method for manufacturing a protonic ceramic fuel cell according to claim 4, wherein the electrolyte layer does not comprises a sintering aid.

9. The method for manufacturing a protonic ceramic fuel cell according to claim 7, wherein, when the anode layer and the electrolyte layer are sintered at the same time, a sintering aid represented by Chemical Formula 1 or Chemical Formula 2 is produced as the yttrium-doped barium cerate-zirconate (BCZY) and the transition metal oxide react in the anode layer:
BaMO₂ [Chemical Formula 1]
BaY₂MO₅ [Chemical Formula 2]
wherein M is nickel (Ni), copper (Cu) or zinc (Zn).

10. The method for manufacturing a protonic ceramic fuel cell according to claim 9, wherein the sintering aid produced in the anode layer is supplied to the electrolyte layer.

11. The method for manufacturing a protonic ceramic fuel cell according to claim 4, wherein the yttrium-doped barium cerate-zirconate (BCZY) is a powder with a diameter smaller than 1 μm.

12. The method for manufacturing a protonic ceramic fuel cell according to claim 4, wherein the sintering is conducted at 1,000-1,450° C.

13. The method for manufacturing a protonic ceramic fuel cell according to claim 5, wherein, in said forming the anode support layer, the yttrium-doped barium cerate-zirconate (BCZY) and the transition metal oxide are mixed at a mass ratio of 40:60 to 60:40.

14. The method for manufacturing a protonic ceramic fuel cell according to claim 6, wherein, in said forming the anode functional layer, the anode functional layer paste is prepared by mixing the yttrium-doped barium cerate-zirconate (BCZY) and the transition metal oxide at a mass ratio of 40:60 to 60:40.

15. The method for manufacturing a protonic ceramic fuel cell according to claim 1, which further comprises:
preparing a cathode paste by dispersing barium-strontium cobalt ferrite (BSCF) in a solvent and forming an interfacial bonding layer by screen-printing the cathode paste on the electrolyte layer;
microwave-sintering the interfacial bonding layer at 700-800° C.;
forming a cathode functional layer by screen-printing the cathode paste on the interfacial bonding layer; and
microwave-sintering the cathode functional layer at 600-700° C.

16. The method for manufacturing a protonic ceramic fuel cell according to claim 1, wherein the yttrium-doped barium cerate-zirconate (BCZY) is prepared by:
mixing a barium source, a cerium source, a zirconia source and an yttrium source;
calcining the mixture firstly at 1,100-1,300° C.; and
calcining the mixture secondly at 1,400-1,500° C.

17. The method for manufacturing a protonic ceramic fuel cell according to claim 16, wherein the yttrium-doped barium cerate-zirconate (BCZY) is a compound represented by Chemical Formula 3:
BaCe_{0.85-x}ZrₓY_{0.15}O_{3-δ} [Chemical Formula 3]
wherein x is from 0.1 to 0.7 and δ is from 0.075 to 0.235.

18. The method for manufacturing a protonic ceramic fuel cell according to claim 16, wherein the barium source is BaCO₃, the cerium source is CeO₂, the zirconia source is ZrO₂ and the yttrium source is Y₂O₃.
